(19) United States
(12) Patent Application Publication
(10) Pub. No.: US 2007/0136136 A1
(43) Pub. Date: Jun. 14, 2007

(54) Method of intercepting and replacing advertising content

(75) Inventor: Misha Nossik, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Thintropy Inc., Ottawa (CA)

(21) Appl. No.: 11/636,657

(22) Filed: Dec. 11, 2006

Related U.S. Application Data
(60) Provisional application No. 60/748,617, filed on Dec. 9, 2005.

(51) Int. Cl. G06Q 30/00

(52) U.S. Cl. 705/14

(57) ABSTRACT

A method of detecting and replacing advertisements within HTML documents provided to a user of a web browser is presented, where the user is operating with a computer display as part of a server based computing environment. The method providing for the replacement of advertisements based upon different criteria according to the computing environment, examples including increasing revenue generated to the owner of the server, referencing products from other divisions of an enterprise owning the server in preference to competitors, removing inappropriate advertisements for young users accessing the server, and providing advertisements in relation to other applications and data running being run by the user on the server.

### FIELD OF THE INVENTION

The instant invention relates generally to Internet advertising, and more particularly to detecting of advertising data within downloaded data and replacing same with different advertising data.

### BACKGROUND

The use of the Internet or World Wide Web as a global communications network and provider of information has increased dramatically over the past decade and has become the ubiquitous source of information for many in their decision making process prior to purchasing of goods. These goods range from subscriptions and online news sources, to purchasing and direct downloading of music (high volume, low per transaction value), through to browsing, viewing and purchasing of white goods, vehicles, cars, and real estate where significant value is attached to each transaction.

As such, nearly every commercial enterprise currently exploits the Internet in order to market, advertise, and sell their respective products and services. The advertising activity can receive effective and immediate responses as the many users are mindful of the many client interface software programs, typically web browsers and search engines, available such as Internet Explorer™, Mozilla™, Google™, Yahoo™, and Ask™. As a result, these enterprises not only maintain a website, which is their electronic presence within the Internet, which provides a full range of product and service information, company information, financial and investor information, media articles, technical or advertising literature, help and support, but they also tend to advertise directly and indirectly within other web pages and browser results pages.

Direct advertising on the Internet is similar to that of magazines, radio, television, etc., in that the advertiser pays a provider of a resource on the Internet to display the advertisers content. Unlike traditional advertising, the displayed advertisement is usually associated with a reference or a navigation element, commonly called a “hyperlink” in the format of a Uniform Resource Location (URL). As such, a user viewing the advertisement can simply “click” on an image or link, and the web browser is directed to a location that is selected by the advertiser and displays the data, images etc. that the advertiser has specified. Such further data can be another advertisement, the home page of the advertiser, a page of their Internet website, a video, a sound clip, or a combination of these. Typically all pages and information displayed are described in Hyper-Text Markup Language (HTML) and are stored on servers connected to the Internet. In many instances the hyperlink opens a new “screen” on the users display so that whilst the advertisement is displayed and they scroll through the advertisers website they do not loose their original document. Many news based organizations sell the space on their website multiple times for each space, such as a banner at the top of the webpage. In these instances the user upon entering the website is presented with one of many advertisers and may see a different advertiser on each entry to the same webpage. This offers lower costs to an advertiser but reduces exposure.

As such, many enterprises will augment their direct advertising campaigns with some form of “indirect advertising”. A typical example of “indirect advertising” is associated with the returned search results from a user when using one of the web browsers to find information. Hence, if we consider an example of a user typing “hybrid SUV” into a web browser when they are seeking a Sports Utility Vehicle (SUV) that has a hybrid drive assembly with a gasoline engine and an electric motor, they will typically be presented with a list of web pages that contain the keywords “SUV” and “hybrid”. If the terms are common then the results can enter hundreds of thousands of referenced web pages or even millions. As such advertisers pay the company providing the search engine or web browser either for placing their advertisement at the top of the list, or within a special section of the webpage such as a sponsored link section above the returned search results or to the side of the results.

Such advertising has become sophisticated with the “advertising rates” calculated based upon many factors such as the frequency of such searches, hence cars, cellular telephones cost more for sponsored links than say left-handed corkscrew, and even the keywords themselves. However, a disadvantage is that the advertisers position within this list is now directly driven by their ability to pay and ensuring their advertisement or sponsored link is displayed may mean capturing a very large number of keywords. Being top of the list for “hybrid SUV” is extremely expensive, as is being number one for say Sony™ in searches for DVD players, CD players, MP3 players, TVs, plasma screens, LCD displays, computers, cameras and cellular telephones.

Due to the immense amount of information on the Internet and the potential for returning millions of referenced HTML documents from a simple search, many web browsers, search engines and other content providers provide content filtration systems that can be used to manage or present content choices to the user. One such example is a portal that convinces a user to visit the portal web site repeatedly by providing a free service, such as e-mail, instant messaging, web hosting, and chat for example. Others provide a user with content derived from selected channels and sources at user-specified intervals, such as every morning for news, or evening for stock prices. Others prompt the user when they are using the web browser or search engine for feedback to actively rank the content provided, both likes and dislikes, thereby building a profile of the user for filtering content. However, with potentially many users sharing a single computer within a household such systems have limitations.

There is therefore monetary benefit for an enterprise which is hosting on its own networked computer server a server based computing solution to providing content filtering and supporting advertisements and sponsored links as outlined supra. However, such an enterprise offers a significant advantage compared to the previous approaches in that the enterprise can guarantee the placement of the advertisement or sponsored link as they manage the content delivery directly. As such it would be advantageous in these enterprises to provide a means of detecting an advertising content within a web page or HTML document and replacing it directly with alternate advertising content provided from the enterprise. In this manner, for example, an enterprise may replace advertising for all services they provide within returned HTML documents or selectively remove advertising relating to a competitor, or inappropriateness. Advantageously such detection and replacement of content providing an enhanced filtering for inappropriate images or content for minors etc.

### SUMMARY OF EMBODIMENTS OF THE INSTANT INVENTION

In accordance with the invention there is provided a method for replacing electronic content comprising providing a server in communication with a network. The server part of a server based computing environment for a plurality of users. First electronic content is provided to a process running on the server, the first electronic content for display to the at least the user. The process running on the server for determining at least a first advertisement meeting at least a predetermined first criteria, selecting at least a second advertisement from a plurality of second advertisements, each of the second advertisements associated with at least a predetermined second criteria, and replacing the first advertisement with the selected second advertisement by modifying the first electronic content to generate modified electronic content, and providing the modified electronic content to the user.

According to another embodiment of the invention there is provided a computer system for managing displayed content comprising of at least two terminals of a plurality of terminals, each terminal comprising at least a display and keyboard and programmed to receive input from a user, operate an application program on a server, and provide output to the terminal, and a server, the server part of a computing environment for running the application programs for the at least two terminals and in communication with a network. The server interconnected to the at least two terminals and programmed to receive first electronic content to a process running on the server, the first electronic content for display to the at least the user, determine at least a first advertisement meeting at least a predetermined first criteria, select at least a second advertisement from a plurality of second advertisements, each of the second advertisements associated with at least a predetermined second criteria, and replace the first advertisement with the selected second advertisement by modifying the first electronic content to generate modified electronic content, and provide the modified electronic content to the user. The process such that the first advertisement included within the received electronic content is removed from received electronic content and replaced.

According to a further embodiment of the invention there is provided a computer readable medium having stored therein data according to a predetermined computing device format, and upon execution of the data by a suitable computing device providing a method for replacement of advertising. The method provided comprising; providing a server in communication with a network, the server part of a server based computing environment for a plurality of users, providing first electronic content to a process running on the server, the first electronic content for display to the at least the user, determining at least a first advertisement meeting at least a predetermined first criteria, selecting at least a second advertisement from a plurality of second advertisements, each of the second advertisements associated with at least a predetermined second criteria, and replacing the first advertisement with the selected second advertisement by modifying the first electronic content to generate modified electronic content, and providing the modified electronic content to the user.

### BRIEF DESCRIPTION OF THE DRAWINGS

FIG. 1 illustrates a representative screen image on a computer display presenting a web page under the control of a web browser application.

FIG. 2A illustrates a simplified flow diagram for detecting advertising data within a web page as part of a server based computing system.

FIG. 2B illustrates a simplified schematic of a server based computing system providing the web application to the user in FIG. 2A.

FIG. 3 illustrates a representative screen image on a computer display presenting a server based computer solution controlled web browser.

FIG. 4 illustrates a representative flow diagram for intercepting and replacing advertising data in a web page.

FIG. 5A illustrates a representative first step of an illustrative embodiment of identifying advertising opportunities within a server based computer solution.

FIG. 5B illustrates a representative second step of an illustrative embodiment of removing advertising within a web page presented by a server based computer solution.

FIG. 5C illustrates a representative third step of an illustrative embodiment of replacing advertising within a web page presented by a server based computer solution.

### DETAILED DESCRIPTION OF EMBODIMENTS OF THE INVENTION

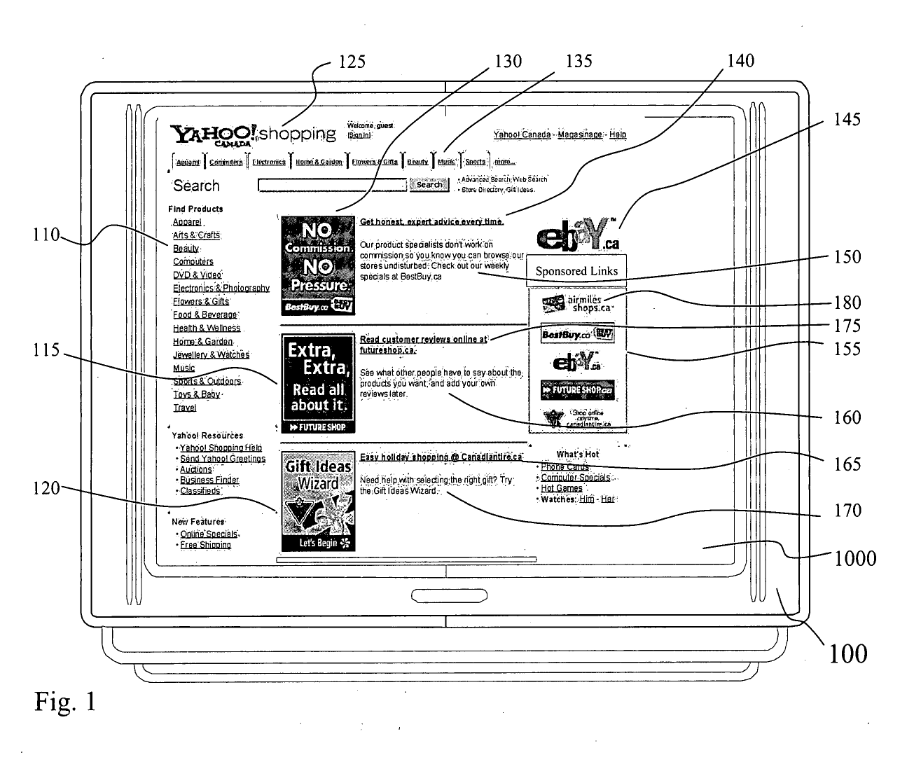

Referring to FIG. 1 shown is a representative screen image on a computer display 100 presenting a web page 1000 under the control of a web browser application. The web page displayed is formulated based on HTML content retrieved from a URL and subsequent processing of the retrieved HTML content by the web browser application. Though different web browser applications sometimes display web pages differently, there have been attempts to standardize the display of web pages, this typically being achieved by processing elements of the HTML content according to boundaries established within the HTML content itself. As shown the web browser application executes within the operating system software. As such, many of the display commands, etc. executed by the web browser application are system level operations that are within the direct control of the operating system.

As shown in FIG. 1, the web page 1000 comprises a banner 125 identifying the web browser employed, in this example Yahoo™, and the section of the browsers contents, in this example “Shopping”. Also shown is a second banner 135 providing common links in the form of hyperlinks that are referenced to other URLs, a category list 110 which provides sub-categories of the shopping. The web page 1000 being a first entry screen in this representative embodiment of the Yahoo Shopping portion of the web browser provides several advertisements from businesses having paid Yahoo™ for the privilege of doing so. First, of these pre-paid advertisements being BestBuy™, a retailer of consumer electronics and entertainment software, represented by a first visual advertisement 130 supporting a hyperlink, a first tagline 140 also supporting a hyperlink, and a first description field 150. Second, and presumably paying less is FutureShop™, a direct competitor to BestBuy™, in a similar format comprising a second visual advertisement 115 supporting a hyperlink, a second tagline 175 also supporting a hyperlink, and a second description field 160.

Below both of these is a third prepaid advertisement for Canadian Tire™, a business of multiple elements including automotive, home, garden and electronics, and as such seeking placement but with a reduced budget for this web page 1000 due to multiple product categories. This is also presented in a similar format comprising a third visual advertisement 120 supporting a hyperlink, a third tagline 165 also supporting a hyperlink, and a third description field 170. To the right of these three advertisements are two sponsored links 145 and 155. The upper of these, the first sponsored link 145 for eBay Canada (eBay.ca™) being a further URL hyperlink. eBay Canada being a major online auction which includes a large section of electronics, new and used, as well as entertainment software and media such as DVDs and CDs. The lower second sponsored link 155 contains multiple URL hyperlinks to the previously mentioned 4 retailers but also includes an additional reference 180 to the Airmiles™ reward program. Typically these sponsored links being retailers other than those with primary advertisements as these sponsored links being smaller and clustered having lower visual focus for the user of the computer display 100. Typically as the user selects one of the visual or text fields associated with a hyperlink and thereby URL the web page 1000 changes based the retrieved HTML content from the referenced URL.

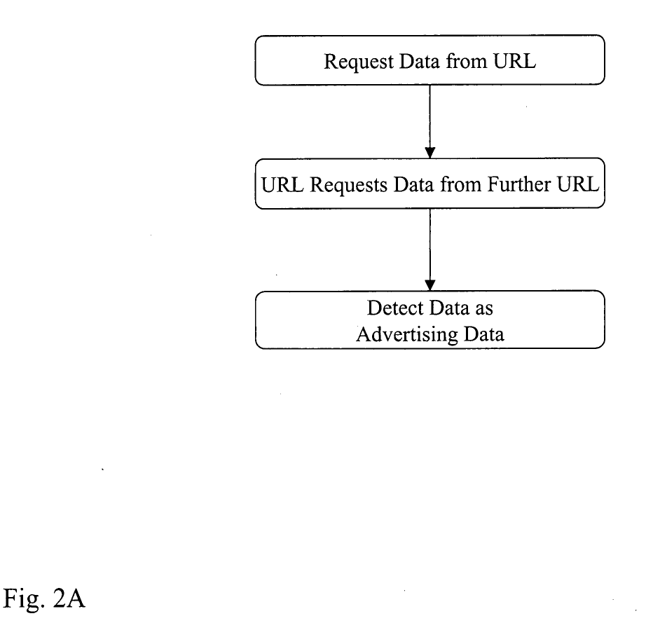

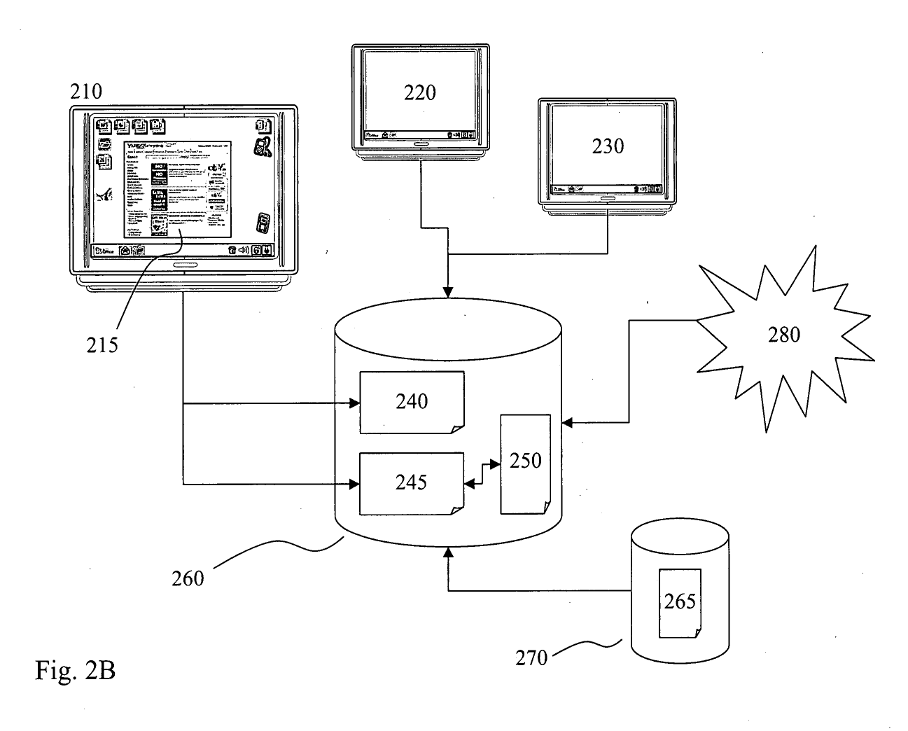

FIG. 2A illustrates a simplified flow diagram for detecting advertising data within a web page, being an application run by a user as part of a server based computing system. Here, a web page such as web page 1000 of FIG. 1 has been presented to the user, such as the Yahoo™ home page with a URL reference www.yahoo.ca. From this the user has selected the “Shopping” option thereby referencing a new URL www.vahoo.ca/shopping, for example. This selection triggers the web browser to request the further HTML content from the URL, which upon receipt is analyzed to determine if it is a source of advertising content. Considering the example of web page 1000 from FIG. 1 then multiple HTML references are included to further URLs that relate to advertising content such as the first through third visual advertisements 130, 115, and 120, the first through third taglines 140, 175, and 165. Other HTML references to further URLs though do not relate to advertising content such as the second banner 135 and category list 110.

When the other URL is a source of advertising content, the content retrieved from the other URL is flagged as advertising content. Of course, there are other ways to identify advertising content including lookup table, databases of advertising content, heuristic analysis of web pages, neural networks, and so forth.

Referring to FIG. 2B shown is a simplified schematic of a server based computing system providing the web application to the user as described above in FIG. 2A. Shown is a first terminal 210 upon which a user is accessing a web page 215 with displayed content and advertising as presented previously in respect of FIGS. 1 and 2. The first terminal 210 is connected to a first server 260 upon which are running a first process 240 and second process 250. The first process 240 relating to the users session upon the first terminal 210 and the second process 245 relating to the web application providing the web page 215 displayed on the first terminal 210. The second process 245 being also in communication with a first content storage 250 on the first server 260 which provides storage for content employed in the replacement process, as presented supra, forming part of the second process 245.

The first server 260 is shown connected also to a second server 270, which contains a second content storage 265, and two additional terminals 220 and 230. Finally the first server is shown connected to the World Wide Web 280 from which content is retrieved in respect of the web activity of the user on the first terminal 210, and which contains advertising content which is replaced by second process 245 with content retrieved from the first content storage 250 and second content storage 265 in determination of the second process 245.

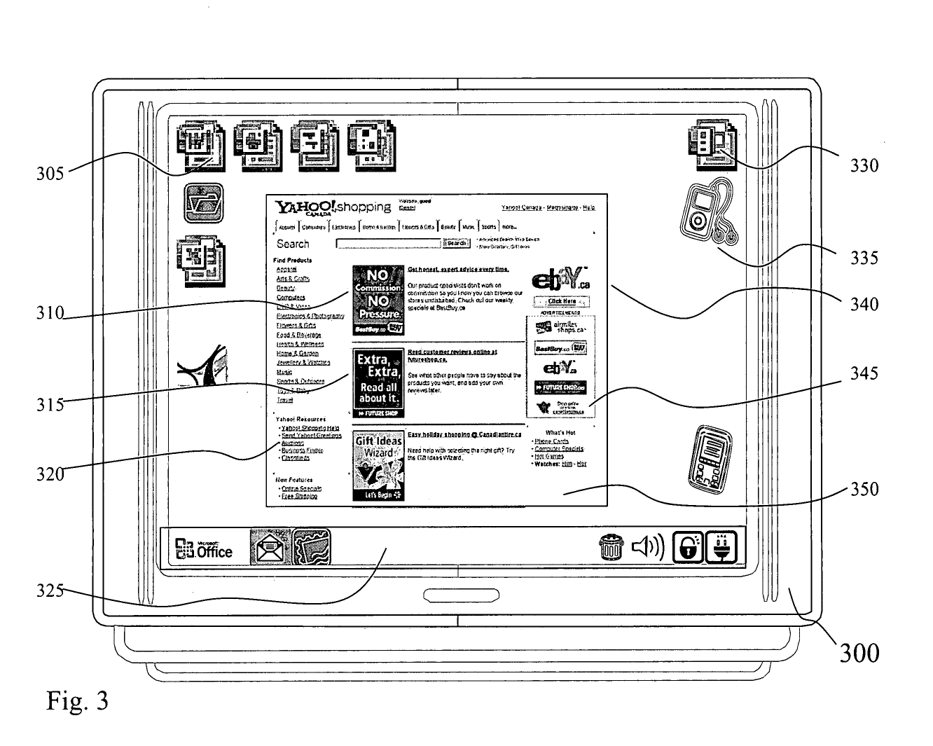

Referring to FIG. 3, shown is a representative screen image on a computer display 300 presenting a server based computer solution controlled web browser. Displayed on the computer display 300 are a toolbar 325 that provides information relating to open applications, links to controls, and displays of other information such as Internet security, power, clock, loudspeaker on or off, and trash for discarding documents and files. It would be evident to one skilled in the art that many variants of toolbars 325 are possible, especially with operating systems such as Microsoft™ XP, 2000 and Apple™ Mac, each of which provides features for allowing users to customize such toolbars 325.

Also shown are a series of applications icons, represented by word processing 305 and desktop publishing 330 which provide shortcuts on the display to applications such as word processing, spreadsheets, drafting, as well as interfaces for electronics such as PDAs and MP3 players 335. Alternatively icons relating to email, web browser, security, virus protection and alike are displayed. The use of application icons being again a feature of the display normally customizable and settable by the user. Options typically including placement, size and design.

Also shown on the computer display 300 is a web browser display 350 that contains images and text as described within the HTML of the URL referenced by the user. Optionally the URL is typed by the user, retrieved from memory according to a list of favorites or default start-up setting or was itself retrieved from a previous URL by a hyperlink. In this representative embodiment the web browser display 350 is a server based computing solution and the overall desktop is functionally controlled by software in execution on a server that is remote from the display. As is shown in FIG. 3, the web browser display 350 contains first advertisement 310, second advertisement 315, first sponsored link 340, second sponsored link 345, and resource listing 320.

The web browser application in execution on the server identifies the advertising content within the web page displayed thereby, and is actively replaced by alternative advertisements as determined by the server. Such alternative advertisements being those generating revenue for the server or an owner thereof. Optionally, such revenue generation may be considered to be that the advertisements relate to products that are manufactured by the owner of the server, which is part of a broader enterprise. Further optionally, such revenue generation may be considered to be that the owner of the server is paid by the advertiser to insert advertisements in place of a competitor's advertisement, or in association with a keyword or keywords. Such examples could include a hotel providing web browsing to guests within the lobby, which when detecting an advertisement for a restaurant inserts an advertisement for the hotel restaurant, or an enterprise allowing employees to browse inserts advertisements for products from other divisions of the enterprise when detecting advertisements for competitors. In many instances of large multinational and diverse enterprises an employee may not be aware of the products offered by their own employer. Consider for instance diverse businesses such as 3M, and General Electric.

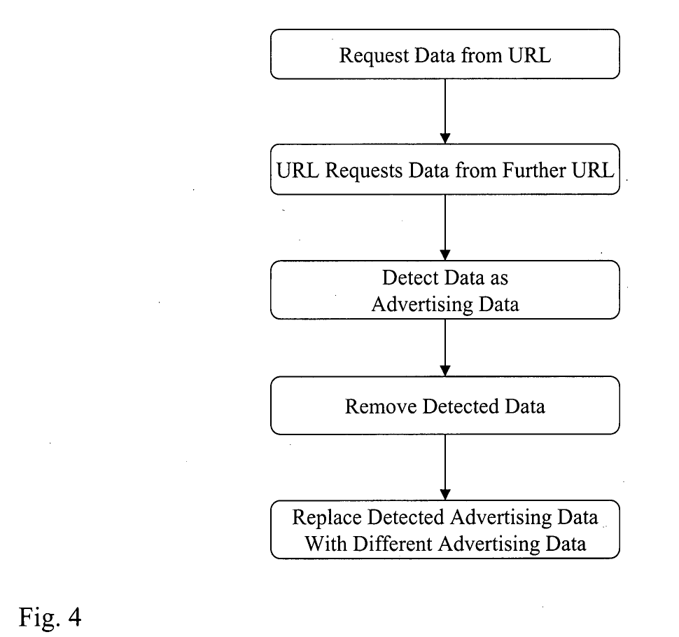

Referring to FIG. 4 illustrated is a representative flow diagram for intercepting and replacing advertising data in a web page. A server in execution of a web browser application receives a request for HTML data from a URL in response to a users action. The URL, and associated HTML data, requests additional data be provided from a further URL. An example of such interlinked URLs being a web page on a website that has a pre-paid permanent slot for an advertiser, which is a single permanent URL reference. Now the website host does not need to make any changes to their webpage as it is the advertisers URL that then references forward to the current advertisement. As such advertisements can be changed daily, hourly, even upon each viewing from an identified user, many alternatives would be evident to one skilled in the art.

The server in execution of the web browser detects a presence of advertising data with the HTML data and/or URL. The server removes the advertising data, and inserts either directly HTML data or further URL data for which the server application generates revenue. Advantageously, the server has access to a type of advertising displayed. For example, Google™ adwords® provides valuable information for selecting advertising data to display. Further, the server has information about the user's preferences and activities to apply to identifying advertising opportunities.

It would be evident to one skilled in the art that many standard techniques for associating advertising with HTML data or URLs exist which can be exploited without departing from the scope of the invention.

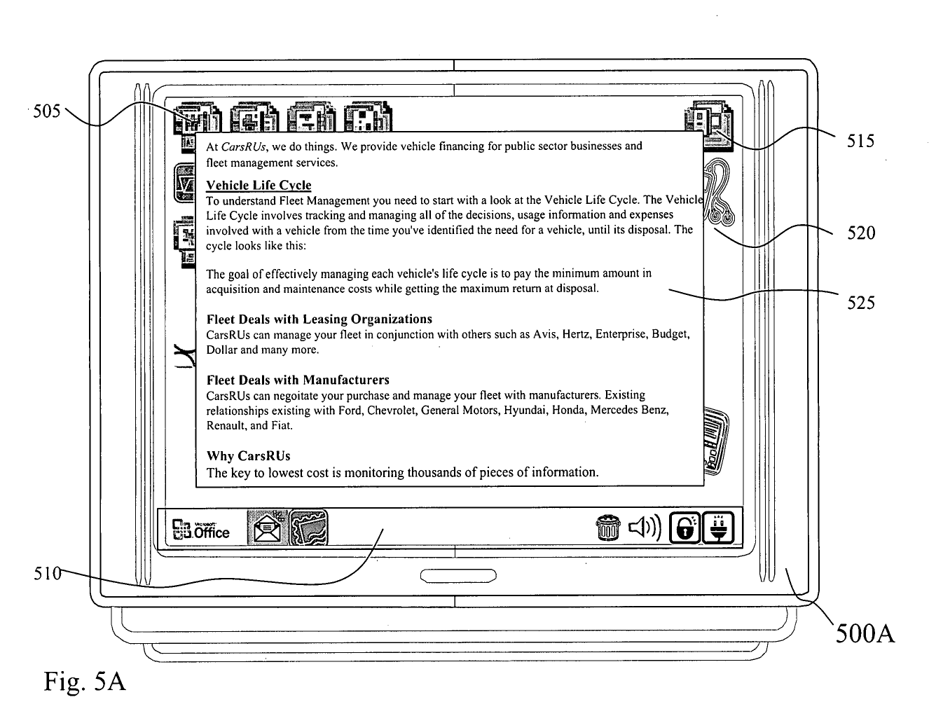

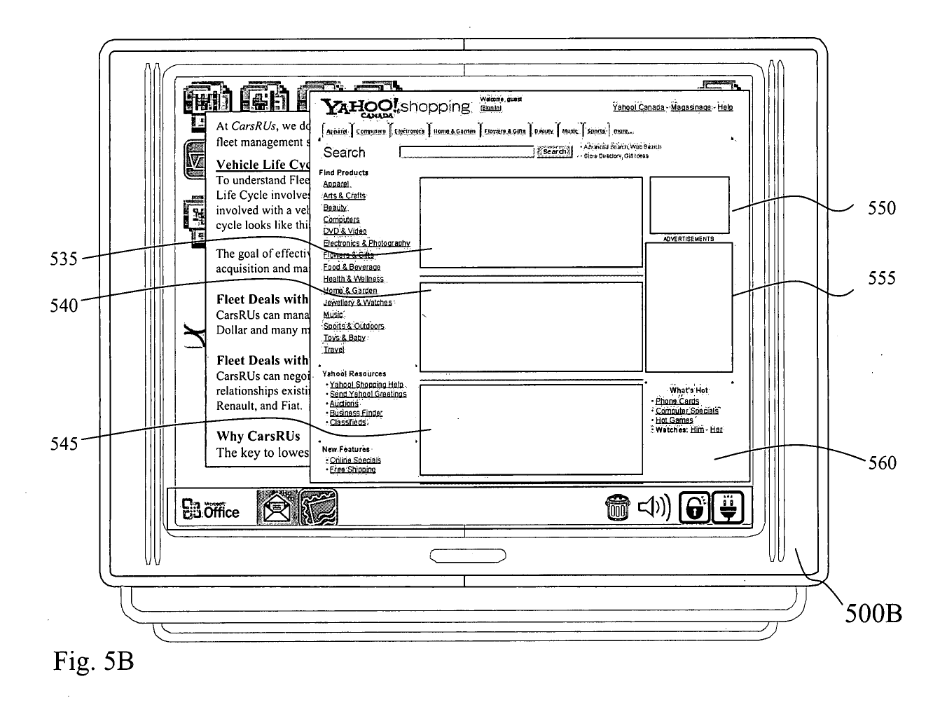

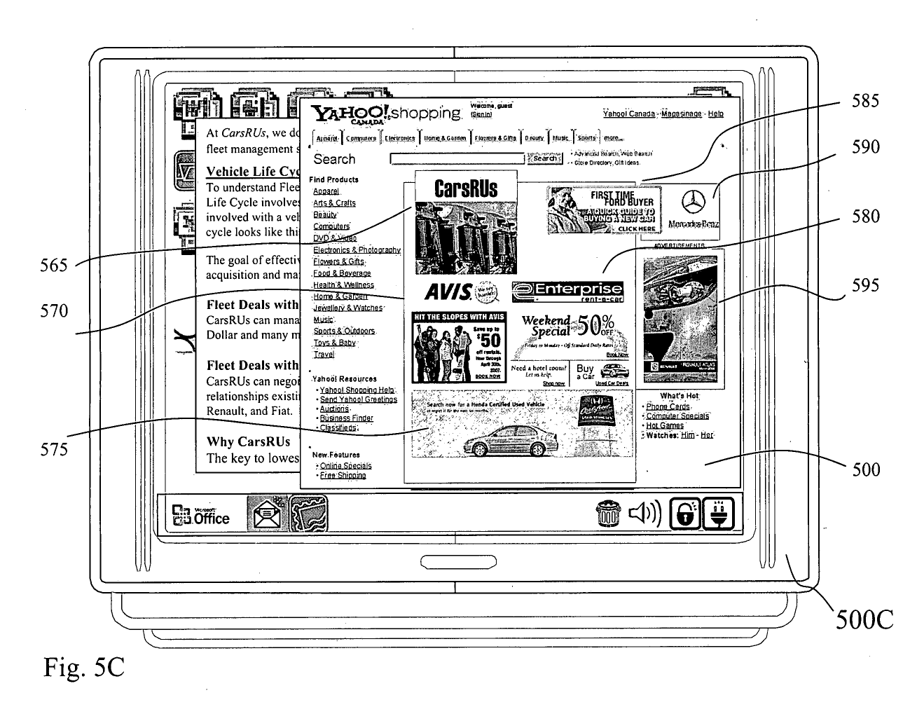

Referring to FIG. 5A, illustrated is an exemplary computer monitor 500A of an illustrative embodiment of identifying advertising opportunities within a server based computer solution. The monitor 500A running a server based computing solution and the overall desktop functionally is controlled by the software in execution on a server remote from the display. The web browser display 500A contains a toolbar 510, which provides information relating to open applications, links to controls, and displays of other information such as Internet security, power, clock, loudspeaker on or off, and trash for discarding documents and files. It would be evident to one skilled in the art that many variants of toolbars 510 are possible. Also shown are a series of applications icons 505 and 515 which provide shortcuts on the display to applications such as word processing, spreadsheets, drafting, etc. Also a toolkit icon 520 is shown in respect of an MP3 player, although optionally such toolkit icons 520 relate to PDAs, networks, wireless access, printers, faxes, etc., as well as other software applications, including but not limited to email, web browser, security, virus protection and the like. The use of application icons being again a feature of the display that is normally customizable and settable by the user. Options typically including placement, size and design.

Also shown is a word processing window 525 being opened in response to the user “double-clicking” one of the application icons, in this case the word processor icon 505. The user has at this point entered text relating to their business, “CarsRUs”. Within this example the software application running within the server based computing environment has an associative link between one open application, which in this representative case is a word processor, and its web browser, which will be evident in reference to FIGS. 5B and 5C subsequently.

In this example the text includes many references to other businesses for sake of clarity in presenting the example. Optionally, the user might be typing a recipe, a list of presents they wish to purchase for friends and relatives at Christmas, a list of items for a bridal registry, a holiday itinerary, and many others too numerous to mention, but keywords for use within a web browser may be extracted from many sources, not only those entered by the user, but alternatively for example from keywords associated with a web page they have opened already, from fields associated with the properties of a document they have opened, which can include hypertext references and URLs also.

Now referring to FIG. 5B the computer monitor 500B is shown at a representative second step. Here, the user of the word processing window 525 of FIG. 5A has initiated opening of a web browser page 560. In doing so the software application, or applications, running within the server based computing environment have associated parts of the received HTML content as representing advertisements. As such, whilst large portions of the requested URL are displayed without change in the web browser page 560, five advertisements 535, 540, 545, 550, and 555 have been removed. At this intermediate step the five advertisements 535, 540, 545, 550, and 555 are simply shown as hatched elements of the web browser page 560. Alternatively, this second step is never displayed as the software application, or applications, running within the server based computing environment replaces the identified advertisements 535, 540, 545, 550 and 555 upon detection with replacement advertisements.

Now referring to FIG. 5C the computer monitor 500C is shown at a third step of this illustrative embodiment of replacing advertising within a web page presented by a server based computer solution. The web browser page 560 of FIG. 5B has now had the five advertisements 535, 540, 545, 550, and 555 replaced to provide a finished web browser page 500.

Within the finished web browser page there are now inserted a series of advertisements:

| | |
|---|---|
| CarsRUs 565 | identified from “CarsRUs” |
| Avis Car Rental 570 | identified from the “Avis” reference |
| Honda Automotive 575 | identified from “Honda” and “vehicle” |
| Enterprise Car Rental 580 | identified from “Enterprise” and “vehicle” |
| Ford Automotive 585 | identified from “Ford” and “vehicle” |
| | combined |
| Mercedes Benz 590 | identified from “Mercedes Benz” |
| Renault 595 | identified from “Renault” |

Within the example provided the advertisements related specifically to enterprises within the word document. Alternatively, the advertisers could have been selected based upon an item described or a combination of items and they are displayed in an order representative of ability to provide all the items with the list. Optionally, the advertisers selected are weighted firstly according to ability of the owner of the server to provide, and then based upon secondary factors. Alternatively, the advertisers are selected based upon having a retail outlet within a predetermined geographical area relative to the user.

Optionally, the server uses the data to determine an advertising content or service provider that will provide the most revenue for a suitable replacement advertisement. Further optionally, the server uses the data to determine advertising content for other applications and/or for the wallpaper or window periphery of the display.

Optionally, at least one embodiment of the invention can be employed to augment other content filtering software and applications. For example, the URL detection and HTML data replacement allows for links within normal websites to be additionally filtered and managed. For example, a catalogue online would not normally be categorized as inappropriate, but a parent may not wish their child to surf the lingerie section of the catalogue, and hence even prior to finding this section the data within the HTML webpage is identified as referencing a lingerie manufacturer and is replaced. This is advantageous as many retailers simply provide limited websites and rely upon their suppliers' websites.

Numerous other embodiments may be envisaged without departing from the spirit or scope of the invention.

What is claimed is:

1. A method for replacing electronic content comprising:
providing a server in communication with a network, the server part of a server based computing environment for a plurality of users,
providing first electronic content to a process running on the server, the first electronic content for display to the at least the user,
determining at least a first advertisement meeting at least a predetermined first criteria,
selecting at least a second advertisement from a plurality of second advertisements, each of the second advertisements associated with at least a predetermined second criteria, and
replacing the first advertisement with the selected second advertisement by modifying the first electronic content to generate modified electronic content, and
providing the modified electronic content to the user.

2. A method according to claim 1 comprising:
providing a request from a user system to the server; and
providing a request from the server to at least another server in communication with the network; and wherein providing first electronic content comprises:
receiving the first electronic content at the server in response to the request.

3. A method according to claim 1 wherein,
providing the modified electronic content comprises modifying at least a portion of the
provided electronic content to insert the second advertisement therein.

4. A method according to claim 1 wherein,
determining at least a first advertisement comprises correlating at least a portion of the provided electronic content with a data source.

5. A method according to claim 1 wherein,
the second criteria is determined in dependence upon a series of actions performed by the user within the server based computing environment.

6. A method according to claim 5 wherein,
actions performed by the user within the distributed computing environment comprise at least one of entering text to at least one of a word processing document, a spreadsheet, a presentation, a process flow chart, an electronic message, a HTML document in preparation, and an instant message.

7. A method according to claim 1 wherein,
selecting a second advertisement comprises selecting the second advertisement for increasing revenue to at least one of the owner of the server.

8. A method according to claim 7 wherein,
increasing revenue comprises generating revenue from at least one of a per replacement basis, a percentage of sales revenue from the provider of the second advertisement, in dependence of the position of the second advertisement within the modified electronic content, the format of the second advertisement provided within the modified electronic content and removing first advertisement whether replaced with one of the second advertisement and a blank advertisement.

9. A method according to claim 7 wherein,
increasing revenue for the owner of the server comprises selecting a second advertisement in dependence upon at least one of a historical revenue of the providers of the second advertisements and remaining durations of contracts with the providers of the second advertisements.

10. A method according to claim 1 wherein,
selecting a second advertisement comprises selecting the second advertisement having the highest correlation between the first criteria and second criteria.

11. A method according to claim 1 wherein,
replacing the first advertisement comprises replacing the advertisement with a plurality of second advertisements.

12. A method according to claim 1 wherein,
replacing the first advertisement with the selected second advertisement comprises at least one of formatting and reformatting the selected second advertisement to fit the same display space as the first advertisement.

13. A method according to claim 1 wherein,
replacing the first advertisement with the selected second advertisement comprises reformatting the provided electronic message to accept selected second advertisement.

14. A method according to claim 1 wherein,
replacing a first advertisement with a second advertisement comprises replacing a text string with a replacement text string within the received electronic content and associating a replacement URL with the replacement text string.

15. A computer system for managing displayed content comprising:
at least two terminals of a plurality of terminals, each terminal comprising at least a display and keyboard and programmed to receive input from a user, operate an application program on a server, and provide output to the terminal, the server, the server part of a computing environment for running the application programs for the at least two terminals and in communication with a network, the server interconnected to the at least two terminals and programmed to:
receive first electronic content to a process running on the server, the first electronic content for display to the at least the user,
determine at least a first advertisement meeting at least a predetermined first criteria,
select at least a second advertisement from a plurality of second advertisements,
each of the second advertisements associated with at least a predetermined second criteria, and
replace the first advertisement with the selected second advertisement by modifying the first electronic content to generate modified electronic content, and
provide the modified electronic content to the user
whereby the first advertisement included within the received electronic content is removed from received electronic content and replaced.

16. A computer readable medium having stored therein data according to a predetermined computing device format, and upon execution of the data by a suitable computing device providing a replacement of advertising comprising:
providing a server in communication with a network, the server part of a server based computing environment for a plurality of users,
providing first electronic content to a process running on the server, the first electronic content for display to the at least the user,
determining at least a first advertisement meeting at least a predetermined first criteria,
selecting at least a second advertisement from a plurality of second advertisements, each of the second advertisements associated with at least a predetermined second criteria, and
replacing the first advertisement with the selected second advertisement by modifying the first electronic content to generate modified electronic content, and providing the modified electronic content to the user.
